(19) United States
(12) Patent Application Publication
(10) Pub. No.: US 2011/0040540 A1
(43) Pub. Date: Feb. 17, 2011

(54) HUMAN WORKLOAD MANAGEMENT SYSTEM AND METHOD

(75) Inventors: Dae Sub Yoon, Daejeon (KR); Jong-Woo Choi, Daejeon (KR); Hyun Suk Kim, Daejeon (KR); Oh Cheon Kwon, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute of Daejeon, Daejeon (KR)

(21) Appl. No.: 12/988,423

(22) PCT Filed: Oct. 13, 2008
(86) PCT No.: PCT/KR2008/005956

§ 371 Date: Oct. 18, 2010

(30) Foreign Application Priority Data
Apr. 30, 2008 (KR) 1020080040239

(51) Int. Cl. G06G 7/48

(52) U.S. Cl. 703/6

(57) ABSTRACT

The present invention relates to a human workload management system and method. In order to safely and efficiently control the system, the present invention measures and manages the user's workload to manage all actions while the user performs a task, particularly when he drives a car. Also, the present invention manages the user's workload when the user interacts with a control system other than to drive.

### CROSS REFERENCE TO RELATED APPLICATIONS

This application claims the benefit of International Application No. PCT/KR2008/005956, filed Oct. 13, 2008, and claims the benefit of Korean Application No. 10-2008-0040239, filed Apr. 30, 2008, the disclosures of all of which are incorporated herein by reference.

### TECHNICAL FIELD

The present invention relates to a human workload management system and method.

### BACKGROUND ART

In a general control system, a user has been able to control various systems such as a car, an airplane, a tractor, or an air traffic control system without any particular limitations. However, as the system becomes more complicated, the user needs to interact with more elements of the system. Further, the user sometimes must interact with the system with an overloaded task that exceeds the user's control capacity.

In this instance, if a long-time task is overloaded to the user, a significant accident may occur in the case of a car or airplane requiring real-time system control. For example, regarding vehicle control, a behavior of distracting the attention of a driver while driving has an influence on traffic accidents.

Therefore, when the user drives for a long time, it is required to prevent various behaviors from distracting the driver's attention, such as dozing off at the wheel, carelessness caused by manipulating a radio or a terminal, or carelessness caused by a driver's small talk. The cases of distracting the driver's attention include carelessness caused by the driver's will of doing something other than driving and carelessness caused by an external event such as a mobile phone's called state from the outside.

In the conventional vehicle system, a skill for measuring a driver's workload and providing him with an appropriate service is rarely realized, or a very basic service is provided to him. A basic example will be a case in which a system called a dialog manager automatically provides a message called from the outside to the user when the driver drives at a speed that is greater than a predetermined speed.

However, the behavior for the driver to use the mobile phone is just one of many behaviors. Therefore, it is needed to consecutively check the driver's condition and secondary tasks according to external events and driver's intention.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a human workload management system and method for measuring and controlling a workload that is a burden when a user uses a control system.

### Technical Solution

An exemplary embodiment of the present invention provides a workload management system including: a user interaction information storage unit for storing and managing information including user condition information, system condition information, external event information, and user secondary task information; a manager for managing event information provided from the outside of the system and priority task information that is a task performed by the user; a load manager for managing user's resource information and user's action information for generating the user's load; a definer for defining a user's goal, a detailed action caused by the goal, and a user's current action; and a simulation engine for computing workload based on information from the user interaction information storage unit, the definer, and the load manager, and generating the user's load.

Another embodiment of the present invention provides a workload managing method including: inferring a user goal from external event information and the user's secondary task information from among predetermined information collected through an information collecting means, the predetermined information including user condition information, system condition information, external event information, and user secondary task information; selecting an action to be currently performed from the inferred user goal; and determining whether the selected action is a scheduled action, and managing the user's workload by performing the action when it is found to be a scheduled action.

### Advantageous Effects

According to the exemplary embodiment of the present invention, the driver's workload can be computed since all behaviors by the driver that may occur during a ride can be managed depending on the driver's ability.

Also, the user's workload can be managed when he interacts with a control system other than driving.

### DESCRIPTION OF DRAWINGS

FIG. 1 shows a configuration diagram of a human work performance management system according to an exemplary embodiment of the present invention.

FIG. 2 shows a configuration diagram of a simulation engine according to an exemplary embodiment of the present invention.

FIG. 3 shows an operational flowchart by a simulation engine according to an exemplary embodiment of the present invention.

FIG. 4 shows a flowchart of a goal inferring method according to an exemplary embodiment of the present invention.

FIG. 5 shows a flowchart of a method for dividing the inferred goal into detailed actions according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or” and “module” described in the specification mean units for processing at least one function and operation, and can be implemented by hardware components or software components and combinations thereof.

For the purpose of safe and efficient system control in an exemplary embodiment of the present invention, a system and method for measuring and managing the user workload will now be described. A vehicle control system will be exemplified for ease of description from among various systems, with reference to accompanying drawings.

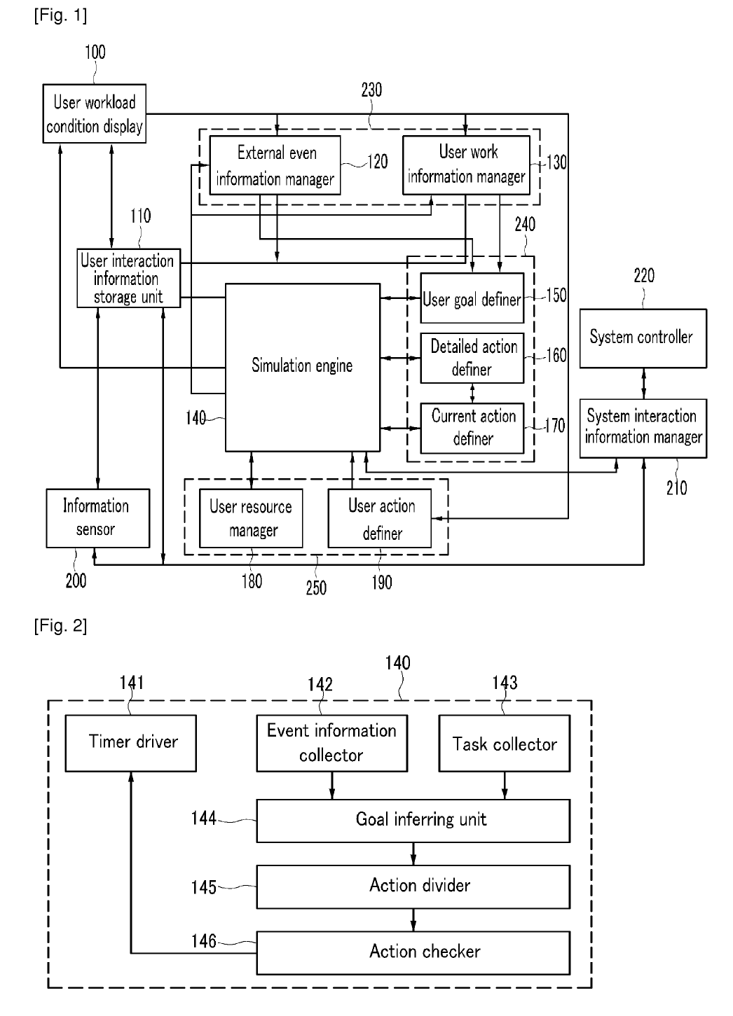

FIG. 1 shows a configuration diagram of a human work performance management system according to an exemplary embodiment of the present invention.

As shown in FIG. 1, the human work performance management system includes a user workload condition display 100, a user interaction information storage unit 110, a manager 230, a definer 240, a load manager 250, a simulation engine 140, an information sensor 200, a system interaction information manager 210, and a system controller 220. Here, the manager 230 includes an external event information manager 120 and a user task information manager 130, and the definer 240 includes a user goal definer 150, a detailed action definer 160, and a current action definer 170. The load manager 250 includes a user resource manager 180 and a user action definer 190.

The user workload condition display 100 displays the user's workload condition. The user reads or changes information of the user interaction information storage unit 110 by referring to workload condition information displayed to the user workload condition display 100.

The user interaction information storage unit 110 stores information on the user's interaction. In detail, the user interaction information storage unit 110 is a global storage unit for globally storing and managing all data including the driver's condition, vehicle's condition, and external environmental condition collected by the information sensor 200.

The external event information manager 120 manages event information generated from the outside. Here, an example of the externally generated event includes an event in which a call is provided to a mobile phone of a user while he was driving a car.

The user task information manager 130 manages information on a secondary task performed by the user in addition to a primary task. That is, the user task information manager 130 manages the secondary task performed by the driver who is a user, and when the driving action is exemplified as a primary task, the secondary task will be an action of calling to a mobile phone.

The simulation engine 140 actually computes the user's workload by using information stored in a plurality of definers, manager, and storage unit, and divides goals stored in the user goal definer 150 into detailed actions by referring to information defined by the user action definer 190.

The simulation engine 140 determines whether a plurality of actions standing by for execution to be performed by the detailed action definer 160 can be simultaneously performed by using sensory demands information and cognitive demands information defined by the user resource manager 180. All actions can be performed simultaneously under the condition of not exceeding the workload.

The user goal definer 150 stores information on the user goal that is managed and generated by the external event information manager 120 and the user task information manager 130. Here, the goal can be defined as pre-conditions, pre-effects, methods, method selection criteria, and post-effects.

The pre-conditions represent the condition before the user goal begins, and the pre-effects indicate the contents that are changed in the user interaction information storage unit 110 as the user goal begins. The methods are for performing the user goal, and are defined as sub-goals and basic actions. The method selection criteria are used to select one of at least two methods. The post-effects represent the contents changed in the user interaction information storage unit 110 when the user goal is finished.

The user performs the user goal based on other user goals and basic actions. Therefore, the basic action is configured with the minimum number of actions performed by the user, and can be defined by pre-conditions, parameters such as a period, driver's sensory organs, cognitive resources, or post-effects.

The detailed action definer 160 defines detailed actions to be performed according to the user's goal.

The current action definer 170 defines and stores the current action from among the detailed actions divided by the simulation engine 140.

The user resource manager 180 manages the user's resources. That is, user resource manager 180 checks and manages parts and capacity used for the user's sensory resource and cognitive resource. Here, the sensory resource includes vision, motor (hands and feet), hearing, and speech, and the cognitive resource includes cognition generated in the driver.

The user action definer 190 defines the user's action. In detail, user action definer 190 defines goals of all the actions generated during a drive, and the user's action on the detailed action to be performed so as to fulfill the goals. New goals and actions can be added to or deleted from the user action definer 190 through the user workload condition display 100.

The information sensor 200 senses all information in real-time. In this instance, information represents the user's condition or the car's condition information, information is collected through various information collecting means (e.g., camera or a microphone) installed in the vehicle, and the collected information is transmitted to the user interaction information storage unit 110.

The system interaction information manager 210 manages the system's interaction information, that is, information that is generated or exchanged during the drive. The system controller 220 controls the system, and the system according to an exemplary embodiment of the present invention indicates a vehicle, to which the exemplary embodiment of the present invention is not restricted.

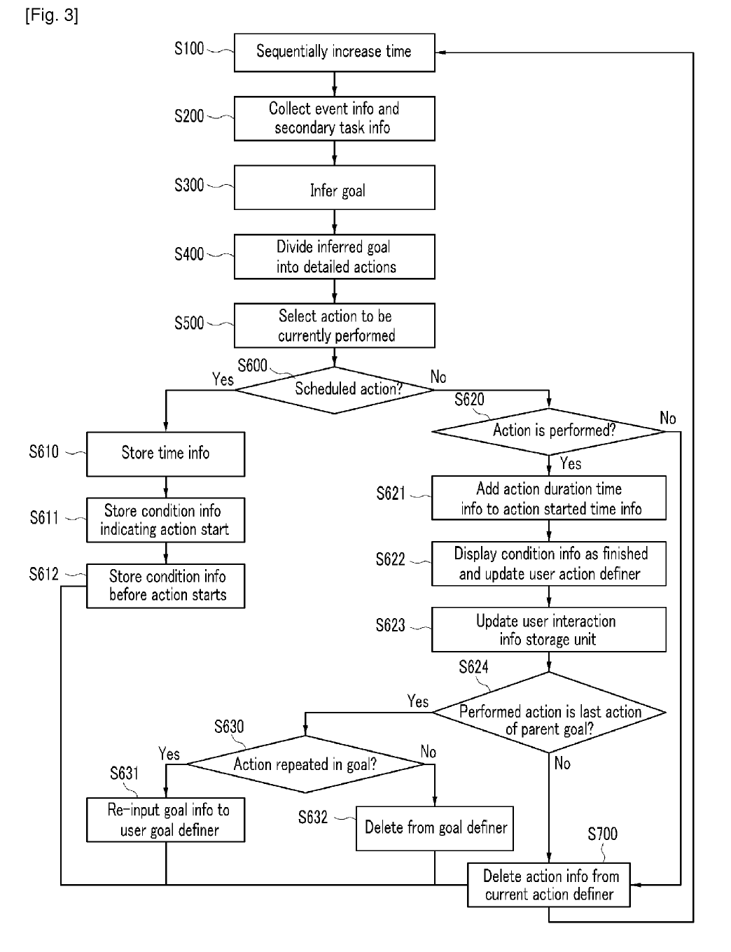

An operation by the simulation engine 140 will now be described with reference to FIG. 2 and FIG. 3.

FIG. 2 shows a configuration diagram of a simulation engine according to an exemplary embodiment of the present invention, and FIG. 3 shows an operational flowchart of a simulation engine according to an exemplary embodiment of the present invention.

As shown in FIG. 2, the simulation engine 140 includes a timer driver 141, an event information collector 142, a task collector 143, a goal inferring unit 144, an action divider 145, and an action checker 146.

The timer driver 141 increases the time that is used as a reference for storing information on the user's action. It will be described in the exemplary embodiment of the present invention that the user starts the vehicle and simultaneously the time is increased, but it is not restricted thereto.

The event information collector 142 receives external event information from among various kinds of information collected by the information sensor 200. The task collector 143 receives the user's secondary task information from among the various kinds of information collected by the information sensor 200.

The goal inferring unit 144 infers the user's goal based on the external event information and the user's secondary task information respectively provided by the event information collector 142 and the task collector 143.

The action divider 145 divides the user's goal inferred by the goal inferring unit 144 into detailed actions, and the action checker 146 selects the action to be currently performed based on information on the detailed action divided by the action divider 145.

One of various variables usable as a reference point under the drive environment is time. All actions are arranged with respect to time and are stored in the user interaction information storage unit 110. Therefore, as shown in FIG. 3, when the user starts the vehicle, the timer driver 141 sequentially increases the time (S100).

The event information collector 142 and the task collector 143 receives the external event information and the user's secondary task information from among the various kinds of information collected by the information sensor 200 through the user interaction information storage unit 110 (S200). The external event information and the secondary task information are needed so as to infer the user's goal, and they are input to the goal inferring unit 144 to infer the goal (S300).

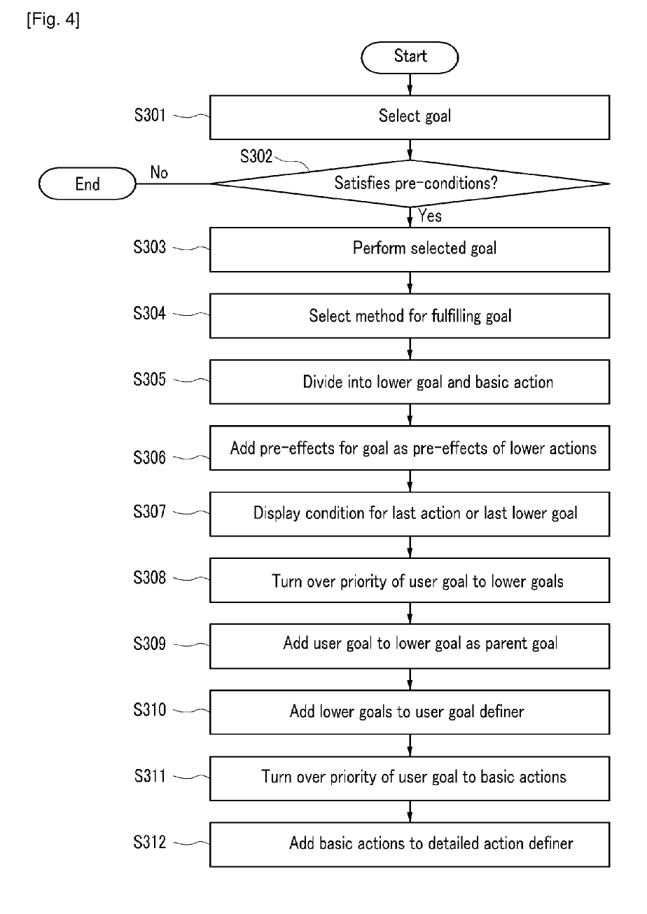

The inferred goal is divided into a detailed action by the action divider 145 (S400), the inferred goal is stored in the user goal definer 150, and the detailed action divided by the action divider 145 is stored in the detailed action definer 160. A method for inferring the goal and a process for dividing it into a detailed action will now be described with reference to FIG. 3 and FIG. 4.

The action checker 146 sequentially selects actions to be currently performed based on information on a plurality of detailed actions divided by the action divider 145 (S500), and determines whether the selected action is a scheduled action (S600). When the selected action is a scheduled action, the action checker 146 receives time information at which the action is started from the timer driver 141 and stores the same (S610), and stores condition information for indicating the action start in the user interaction information storage unit 110 (S611).

The action checker 146 stores the condition before the action starts and the condition after the action starts in the user interaction information storage unit 110 and updates them (S612), and deletes information on the performed action from the detailed action definer 160 (S700).

When the selected action is not a scheduled action according to the determination result of S600, the action checker 146 checks whether the current action is performed (S620). When the action is not performed, the action checker 146 deletes information on the action from the detailed action definer 160 S700. However, when the action is performed, the action checker 146 receives time information at which the action started from the timer driver 141 and adds an action duration time to the time information (S621), marks condition information with “finished,” stores it in the user action definer 190 to update it (S622), and simultaneously stores the condition after the action is finished in the user interaction information storage unit 110 to update it (S623).

The action checker 146 determines whether the currently performed action is the last action for the user goal by referring to information of the detailed action definer 160 (S624). When it is not the last action, the action checker 146 deletes information on the current action from the current action definer 170 (S700).

However, when it is the last action, the action checker 146 checks whether to repeat the current action (S630). When the current action is found to be repeated, the action checker 146 re-inputs the user goal information on the current action to the user goal definer 150 (S631). However, when the current action is found to be not repeated, all the actions corresponding to the user goal are finished, and hence, the action checker 146 deletes the user goal from the user goal definer 150 (S632) and deletes information on the current action from the current action definer 170 (S700).

A method for inferring the user goal in S300 will now be described with reference to FIG. 4.

FIG. 4 shows a flowchart for a goal inferring method according to an exemplary embodiment of the present invention.

The goal inferring unit 144 selects one of the user goals stored in the user goal definer 150 (S301), and checks whether the selected user goal satisfies the pre-conditions (S302). When the selected user goal does not satisfy the pre-conditions, there is no need to perform the corresponding goal, so the user goal definer 150 stops the simulation engine 140 receiving the corresponding goal and processing the same.

When the selected user goal satisfies the pre-conditions, the simulation engine 140 performs the corresponding goal (S303). In this instance, when there are many methods for fulfilling the corresponding goal, the simulation engine 140 selects one of them (S304) according to a predefined rule or in a random manner.

The goal inferring unit 144 divides the selected method into a lower goal and a basic action (S305), add the pre-effects for the goal as the first action of the goal or as pre-effects for the first lower actions (S306), and displays “TRUE” when the action or the lower goal is the last action or the last lower action (S307).

The goal inferring unit 144 turns over the priority of the user goal to the lower goals (S308), adds a user goal to the lower goals as a parent goal (S309), and adds the lower goals to the user goal definer 150 according to the order in the selected method (S310).

The goal inferring unit 144 turns over the priority of the user goal to the basic actions, and turns over the goal to the basic actions as a parent goal (S311). The goal inferring unit 144 adds basic actions to the detailed action definer 160 according to an order (S312), and fulfills the goal when finishing the above-noted process.

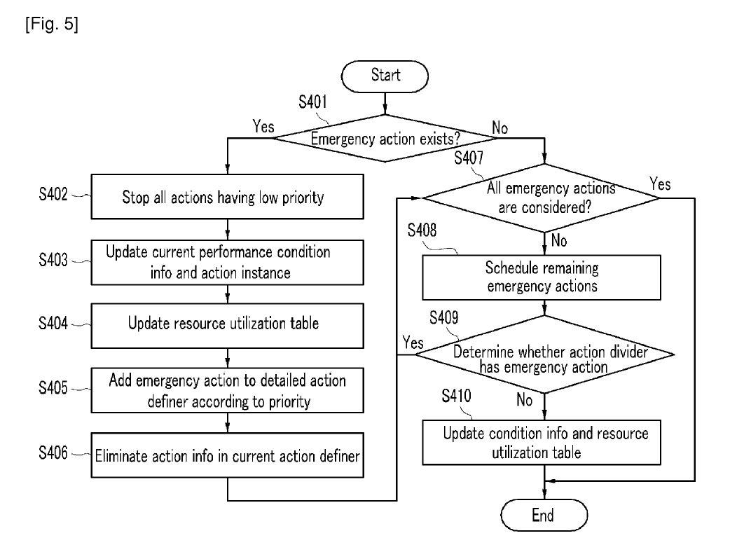

A method for dividing the goal inferred in S400 of FIG. 2 into detailed actions will now be described with reference to FIG. 5.

FIG. 5 shows a flowchart of a method for dividing the inferred goal according to an exemplary embodiment of the present invention into a detailed action.

The first thing for the action divider 145 to do in order to divide the inferred goal into a detailed action is to check whether there is an emergency action having emergency priority information from among a plurality of actions. Therefore, the action divider 145 determines whether the action includes emergency priority information (S401), and transmits information to the simulation engine 140 (S402) so as to stop all the actions having lower priorities stored in the current action definer 170 when the action includes emergency priority information.

The action divider 145 updates an action instance together with condition information with the performed current action so as to update all action instances relating to the current performance (S403), and updates a resource utilization table in the user resource manager 180 (S404). In this instance, the resource utilization table is expressed as Table 1.

TABLE 1

| Resource | Capacity (%) | Current action |
|---|---|---|
| Vision | 20 | Looking front |
| Left hand motion | 0 | Blinker |
| Right hand motion | 0 | Wheel operation |
| Left foot motion | 100 | — |
| Right foot motion | 0 | Accelerator |
| Hearing | 80 | Noise |
| Speech | 100 | — |
| Cognition | 60 | Complex |
| Entire workload | | |

The resource utilization table shown in Table 1 is used to determine the driver's workload or determine whether actions that are simultaneously executable can be performed. Table 1 shows the resource utilization table when the driver turns right. In Table 1, the first column indicates exemplified various resource channels.

The second column indicates the available capacity when various resource channels are concurrently used. When the available capacity for a predetermined channel is given as 0, the task of the corresponding channel indicates the applied state of the load, and when the entire workload is given as 0, it means that the load is applied to the driver's task. The simulation engine 140 determines whether to be able to add a new action based on the available capacity of the second column. The third column represents an action that is currently performed by the driver according to each channel.

When the action divider 145 updates the resource utilization table, the simulation engine 140 adds emergency action information to the detailed action definer 160 according to the priority (S405), and simultaneously deletes information on the actions in the current action definer 170 (S406).

The simulation engine 140 determines whether an emergency action having emergency priority information in the detailed action definer 160 is considered (S407), and the action divider 145 is finished when the emergency action is considered. However, when the emergency actions to be considered still remain in the detailed action definer 160, the simulation engine 140 schedules performance of the remaining emergency actions by referring to the resource utilization table S408, and determines whether the emergency action is provided in the action divider 145 (S409).

When the emergency action is provided in the action divider 145, the simulation engine 140 performs the process after S407 for determining consideration of all emergency actions for the corresponding action. However, when there is no emergency action in the action divider 145, the simulation engine 140 schedules the emergency action condition (S408), moves the emergency action from the detailed action definer 160 to the current action definer 170, and updates the resource utilization table (S410). The above-noted process is repeated until all the emergency actions in the detailed action definer 160 are performed, and the action divider 145 stops when no further actions to be considered are found in the detailed action definer 160.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. In a system for managing a user's workload, a workload management system comprising:
a user interaction information storage unit for storing and managing information including user condition information, system condition information, external event information, and user secondary task information;
a manager for managing event information provided from the outside of the system and priority task information that is a task performed by the user;
a load manager for managing user's resource information and user's action information for generating the user's load;
a definer for defining a user's goal, a detailed action caused by the goal, and a user's current action; and
a simulation engine for receiving information from the user interaction information storage unit, the definer, and the load manager, and generating the user's load.

2. The workload management system of claim 1, further comprising:
a user workload condition display for displaying the user's load degree generated by the simulation engine and information of the user interaction information storage unit;
an information sensor for collecting the user's condition information, system condition information, and external environment condition information; and
a system controller for controlling the user interaction information storage unit, the manager, the definer, the load manager, the simulation engine, the user load condition display, and the information sensor through the user interaction information manager.

3. The workload management system of claim 2, wherein
the manager includes:
an external event information manager for managing event information that is generated from the outside of the system;
a user task information manager for managing information on a secondary task performed by the user, the secondary task being performed other than the priority task; and
a system interaction information manager for managing interaction information of the system.

4. The workload management system of claim 2, wherein
the definer includes:
a user goal definer for defining and storing information on the user's goal managed and generated by the manager;
a detailed action definer for defining a detailed action to be performed according to the user's goal; and
a current action definer for defining an action that is currently performed from among detailed action information divided by the simulation engine, and storing the same.

5. The workload management system of claim 2, wherein
the load manager includes:
a user resource manager for checking and managing the capacity used for the user's resource information, the resource information being divided into a first resource and a second resource; and
a user action definer for defining a goal performed by the user and the user's detailed action to be performed so as to fulfill the goal, and storing and managing a goal and a detailed action that are changed or added according to an input by the user.

6. The workload management system of claim 1, wherein
the simulation engine includes:
an event information collector for receiving external event information from among information collected by the information sensor;
a task collector for receiving the user's secondary task information from among the information collected by the information sensor;
a goal inferring unit for inferring the user's goal from the received external event information and secondary task information;
an action divider for dividing the user's goal inferred by the goal inferring unit into detailed actions; and
an action checker for selecting the action to be currently performed based on information on the detailed actions divided by the action divider.

7. The workload management system of claim 6, further comprising:
a timer driver for increasing a time that is used as a reference for storing information on the user's action.

8. In a method for managing a user's workload, a workload managing method comprising:
inferring a user goal from external event information and the user's secondary task information from among predetermined information collected through an information collecting means, the predetermined information including user condition information, system condition information, external event information, and user secondary task information;
selecting an action to be currently performed from the inferred user goal; and
determining whether the selected action is a scheduled action, and managing the user's workload by performing the action when it is found to be a scheduled action.

9. The workload managing method of claim 8, wherein
the selecting of an action includes:
classifying a plurality of detailed actions from the inferred user goal; and
selecting the action to be currently performed from among the classified detailed actions.

10. The workload managing method of claim 9, wherein
the classifying of detailed actions includes:
determining whether there is an emergency action having emergency priority information;
controlling the actions other than the emergency action to be stopped, and updating condition information of all actions that are currently performed and an action instance;
updating a resource utilization table according to stopping of the action;
adding information on an emergency action to a detailed action definer based on the emergency priority information, and eliminating action stopped action information in the current action definer;
determining whether emergency actions remain, and scheduling performance of the emergency action by referring to the resource utilization table for the remaining emergency actions; and
updating condition information of the scheduled emergency action, and updating the resource utilization table for the emergency action.

11. The workload managing method of claim 10, further comprising,
when there is no emergency action having the emergency priority information:
determining whether all actions other than the emergency action are considered;
scheduling performance on one of the remaining actions when all the actions are not considered; and
determining whether there is an emergency action, and when there is no emergency action, updating condition information for one of the actions, and updating the resource utilization table.

12. The workload managing method of claim 8, wherein
the performing of an action includes:
storing start time information when the action is performed and the action information;
updating condition information before the action is started and condition information after the action is started in the information storage unit when the action is performed; and
deleting the action information from the current action definer.

13. The workload managing method of claim 8, wherein the method includes,
when the selected action is not a scheduled action:
determining whether the selected action is an action that is currently performed;
adding action duration time information to the action started time information when it is an action that is currently performed;
displaying condition information of the action as finished, and updating a resource utilization table; and
updating condition information after the action is finished in an information storage unit.

14. The workload managing method of claim 13, further comprising,
after the updating in the information storage unit:
determining whether the action is the last action;
determining whether the action is repeated in the goal when it is the last action;
inserting information on the goal when it is a repeated action in the goal, and deleting information on the goal when it is not a repeated action.

15. The workload managing method of claim 8, wherein
the inferring of a user goal includes:
selecting one of a plurality of goals stored in a system, and determining whether the goal satisfies pre-conditions;
performing the goal, and selecting one of a plurality of methods for fulfilling the goal when the goal satisfies pre-conditions;
dividing the selected method into a lower goal and a basic action;
adding pre-effects for the goal as the first action of the goal or pre-effects of the first lower actions;
turning over the priority of the goal to the lower goals, and adding the goal for the lower goals as a parent goal; and
turning over the goal to the basic action as a parent goal.
